(19) United States
(12) Patent Application Publication
(10) Pub. No.: US 2020/0410927 A1
(43) Pub. Date: Dec. 31, 2020

(54) Pixel Circuit, Driving Method thereof, and Display Apparatus

(71) Applicant: BOE Technology Group Co., Ltd., Beijing (CN)

(72) Inventors: Tieshi WANG, Beijing (CN); Shengnan LI, Beijing (CN); Wei QIN, Beijing (CN); Dongxu HAN, Beijing (CN)

(21) Appl. No.: 16/904,581

(22) Filed: Jun. 18, 2020

(30) Foreign Application Priority Data
Jun. 28, 2019 (CN) 201910576749.3

(51) Int. Cl. G09G 3/325; G09G 3/3266; G09G 3/3275

(52) U.S. Cl. CPC G09G 3/325; G09G 3/3275; G09G 3/3266

(57) ABSTRACT

A pixel circuit, a driving method thereof, and a display apparatus are disclosed. The pixel circuit is configured to drive a light emitting element to emit light, and includes: a node control sub-circuit, a light emitting control sub-circuit and a driving sub-circuit; the node control sub-circuit is connected with a first scanning terminal, a second scanning terminal, a reset signal terminal, an initial signal terminal, a first node, a second node, a third node, a data signal terminal and a ground terminal respectively; the light emitting control sub-circuit is connected with a first power supply terminal, a light emitting control terminal and a fourth node respectively; the driving sub-circuit is connected with the first node, the second node, the third node and the fourth node respectively; and the light emitting element is connected with the first node and a second power supply terminal respectively.

### CROSS-REFERENCE TO RELATED APPLICATION

The present application claims the priority of the Chinese patent application No. 201910576749.3 filed to the CNIPA on Jun. 28, 2019, the content of which is hereby incorporated by reference.

### TECHNICAL FIELD

The present disclosure relates to, but is not limited to, the technical field of display, in particular to a pixel circuit and a driving method thereof, and a display apparatus.

### BACKGROUND

Organic Light-Emitting Diode (OLED) is currently one of hotspots in a research field of flat panel displays. Compared with Liquid Crystal Displays (LCDs), OLED displays have advantages such as low energy consumption, low production cost, self-luminescence, wide viewing angle, and fast response speed.

Unlike the LCD which uses stable voltage to control brightness, the OLED adopts current driving, and uses a stable current to control light emission. The OLED display outputs a current to the OLED through a driving transistor which is included in a pixel driving circuit in each pixel, to drive the OLED to emit light.

### SUMMARY

The following is a summary of the subject matter described in detail in the present disclosure. This summary is not intended to limit the protection scope of the claims.

In a first aspect, the present disclosure provides a pixel circuit, configured to drive a light emitting element to emit light, the pixel circuit including: a node control sub-circuit, a light emitting control sub-circuit and a driving sub-circuit; the node control sub-circuit is connected with a first scanning terminal, a second scanning terminal, a reset signal terminal, an initial signal terminal, a first node, a second node, a third node, a data signal terminal and a ground terminal respectively, and is configured to provide a signal of the initial signal terminal to the first node under control of the reset signal terminal, provide a signal of the data signal terminal to the second node under control of the first scanning terminal, and provide a signal of the ground terminal to the second node or provide a signal of the ground terminal to the second node and the third node under control of the second scanning terminal; the light emitting control sub-circuit is connected with the first power supply terminal, the light emitting control terminal and a fourth node respectively, and is configured to provide a signal of the first power supply terminal to the fourth node under control of the light emitting control terminal; the driving sub-circuit is connected with the first node, the second node, the third node and the fourth node respectively, and is configured to provide a driving current to the first node under control of the second node, the third node and the fourth node; the light emitting element is connected with the first node and the second power supply terminal respectively.

In some possible implementations, the driving sub-circuit includes: a driving transistor, wherein the driving transistor is a double-gate transistor; a first control electrode of the double-gate transistor is connected with the second node, a second control electrode of the double-gate transistor is connected with the third node, a first electrode of the double-gate transistor is connected with the fourth node, and a second electrode of the double-gate transistor is connected with the first node.

In some possible implementations, the light emitting element includes: an organic light emitting diode; an anode of the organic light emitting diode is connected with the first node, and a cathode of the organic light emitting diode is connected with the second power supply terminal.

In some possible implementations, the node control sub-circuit includes: a first control sub-circuit, a second control sub-circuit and a third control sub-circuit; the first control sub-circuit is connected with the reset signal terminal, the initial signal terminal and the first node respectively, and is configured to provide a signal of the initial signal terminal to the first node under control of the reset signal terminal; the second control sub-circuit is connected with the first scanning terminal, the data signal terminal, the ground terminal and the second node respectively, and is configured to, under control of the first scanning terminal, provide a signal of the data signal terminal to the second node, and store a voltage difference between the second node and the ground terminal; the third control sub-circuit is connected with the second scanning terminal, the ground terminal, the third node and the first node respectively, and is configured to, under control of the second scanning terminal, provide the signal of the ground terminal to the third node, and store a voltage difference between the first node and the third node.

In some possible implementations, the second control sub-circuit is further connected with the second scanning terminal, and is configured to provide a signal of the ground terminal to the second node under control of the second scanning terminal.

In some possible implementations, the first control sub-circuit includes: a first switching transistor; a control electrode of the first switching transistor is connected with the reset signal terminal, a first electrode of the first switching transistor is connected with the initial signal terminal, and a second electrode of the first switching transistor is connected with the first node.

In some possible implementations, the second control sub-circuit includes: a second switching transistor and a first capacitor; a control electrode of the second switching transistor is connected with the first scanning terminal, a first electrode of the second switching transistor is connected with the data signal terminal, and a second electrode of the second switching transistor is connected with the second node; a first terminal of the first capacitor is connected with the second node, and a second terminal of the first capacitor is connected with the ground terminal.

In some possible implementations, the third control sub-circuit includes: a third switching transistor and a second capacitor; a control electrode of the third switching transistor is connected with the second scanning terminal, a first electrode of the third switching transistor is connected with the ground terminal, and a second electrode of the third switching transistor is connected with the third node; a first terminal of the second capacitor is connected with the third node, and a second terminal of the second capacitor is connected with the first node.

In some possible implementations, the second control sub-circuit includes: a second switching transistor, a first capacitor and a fifth switching transistor; a control electrode of the second switching transistor is connected with the first scanning terminal, a first electrode of the second switching transistor is connected with the data signal terminal, and a second electrode of the second switching transistor is connected with the second node; a first terminal of the first capacitor is connected with the second node, and a second terminal of the first capacitor is connected with the ground terminal; a control electrode of the fifth switching transistor is connected with the second scanning terminal, a first electrode of the fifth switching transistor is connected with the ground terminal, and a second electrode of the fifth switching transistor is connected with the second node.

In some possible implementations, the light emitting control sub-circuit includes: a fourth switching transistor; a control electrode of the fourth switching transistor is connected with the light emitting control terminal, a first electrode of the fourth switching transistor is connected with the first power supply terminal, and a second electrode of the fourth switching transistor is connected with the fourth node.

In some possible implementations, a voltage value of the signal of the data signal terminal includes: a first voltage value and a second voltage value; the first voltage value is less than the second voltage value; the first voltage value is the same as a voltage value of the signal of the ground terminal.

In some possible implementations, a voltage value of the signal of the initial signal terminal is less than a difference between a voltage value of the signal of the ground terminal and a threshold voltage of the driving transistor.

In some possible implementations, a voltage value of the signal of the first power supply terminal is greater than a voltage value of the signal of the second power supply terminal; a voltage value of the signal of the initial signal terminal is less than a voltage value of the signal of the second power supply terminal.

In some possible implementations, the node control sub-circuit includes: a first switching transistor, a second switching transistor, a third switching transistor, a first capacitor and a second capacitor, the light emitting control sub-circuit includes: a fourth switching transistor, and the driving sub-circuit includes: a driving transistor; a control electrode of the first switching transistor is connected with the reset signal terminal, a first electrode of the first switching transistor is connected with the initial signal terminal, and a second electrode of the first switching transistor is connected with the first node; a control electrode of the second switching transistor is connected with the first scanning terminal, a first electrode of the second switching transistor is connected with the data signal terminal, and a second electrode of the second switching transistor is connected with the second node; a first terminal of the first capacitor is connected with the second node, and a second terminal of the first capacitor is connected with the ground terminal; a control electrode of the third switching transistor is connected with the second scanning terminal, a first electrode of the third switching transistor is connected with the ground terminal, and a second electrode of the third switching transistor is connected with the third node; a first terminal of the second capacitor is connected with the third node, and a second terminal of the second capacitor is connected with the first node; a control electrode of the fourth switching transistor is connected with the light emitting control terminal, a first electrode of the fourth switching transistor is connected with the first power supply terminal, and a second electrode of the fourth switching transistor is connected with the fourth node; the driving transistor is a double-gate transistor, a first control electrode of the double-gate transistor is connected with the second node, a second control electrode of the double-gate transistor is connected with the third node, a first electrode of the double-gate transistor is connected with the fourth node, and a second electrode of the double-gate transistor is connected with the first node.

In some possible implementations, the node control sub-circuit includes: a first switching transistor, a second switching transistor, a third switching transistor, a fifth switching transistor, a first capacitor and a second capacitor, the light emitting control sub-circuit includes: a fourth switching transistor, and the driving sub-circuit includes: a driving transistor; a control electrode of the first switching transistor is connected with the reset signal terminal, a first electrode of the first switching transistor is connected with the initial signal terminal, and a second electrode of the first switching transistor is connected with the first node; a control electrode of the second switching transistor is connected with the first scanning terminal, a first electrode of the second switching transistor is connected with the data signal terminal, and a second electrode of the second switching transistor is connected with the second node; a first terminal of the first capacitor is connected with the second node, and a second terminal of the first capacitor is connected with the ground terminal; a control electrode of the third switching transistor is connected with the second scanning terminal, a first electrode of the third switching transistor is connected with the ground terminal, and a second electrode of the third switching transistor is connected with the third node; a first terminal of the second capacitor is connected with the third node, and a second terminal of the second capacitor is connected with the first node; a control electrode of the fourth switching transistor is connected with the light emitting control terminal, a first electrode of the fourth switching transistor is connected with the first power supply terminal, and a second electrode of the fourth switching transistor is connected with the fourth node; a control electrode of the fifth switching transistor is connected with the second scanning terminal, a first electrode of the fifth switching transistor is connected with the ground terminal, and a second electrode of the fifth switching transistor is connected with the second node; the driving transistor is a double-gate transistor, a first control electrode of the double-gate transistor is connected with the second node, a second control electrode of the double-gate transistor is connected with the third node, a first electrode of the double-gate transistor is connected with the fourth node, and a second electrode of the double-gate transistor is connected with the first node.

In a second aspect, the present disclosure also provides a display apparatus, including: a gate driving circuit and pixel circuits arranged in an array, wherein the pixel circuits are the above pixel circuits; the gate driving circuit includes: multiple cascaded shift registers, wherein each stage of the shift registers includes an output terminal, and the output terminal of the N-th stage shift register is connected with a first scanning terminal of the N-th row of the pixel circuits, and is configured to provide a gate driving signal to the first scanning terminal of the N-th row of the pixel circuits.

In some possible implementations, when a node control sub-circuit is configured to provide a signal of a ground terminal to a second node and a third node, the first scanning terminal of the N-th row of the pixel circuits is connected with the output terminal of the N-th stage shift register, a second scanning terminal of the N-th row of the pixel circuits is connected with the output terminal of the (N−1)-th stage shift register, and a reset signal terminal of the N-th row of the pixel circuits is connected with the output terminal of the (N−2)-th stage shift register.

In a third aspect, the present disclosure also provides a method for driving a pixel circuit, used for driving the above pixel circuit, the method including: providing, by a node control sub-circuit a signal of an initial signal terminal to a first node under control of a reset signal terminal, providing, by the node control sub-circuit, a signal of a data signal terminal to a second node under control of a first scanning terminal, and providing, by the node control sub-circuit, a signal of a ground terminal to the second node or providing a signal of a ground terminal to the second node and a third node under control of a second scanning terminal; providing, by a light emitting control sub-circuit, a signal of a first power supply terminal to a fourth node under control of a light emitting control terminal; providing, by a driving sub-circuit, a driving current to the first node under control of the second node, the third node and the fourth node.

In some possible implementations, the node control sub-circuit includes: a first control sub-circuit, a second control sub-circuit and a third control sub-circuit; when the node control sub-circuit provides the signal of the ground terminal to the second node, providing, by the node control sub-circuit a signal of the initial signal terminal to the first node under control of the reset signal terminal, providing, by the node control sub-circuit, the signal of the data signal terminal to the second node under control of the first scanning terminal, and providing, by the node control sub-circuit, the signal of the ground terminal to the second node or providing the signal of the ground terminal to the second node and the third node under control of the second scanning terminal, includes: providing, by the first control sub-circuit, the signal of the initial signal terminal to the first node under control of the reset signal terminal; under control of the first scanning terminal, providing, by the second control sub-circuit, the signal of the data signal terminal to the second node, and storing a voltage difference between the second node and the ground terminal; under the control of the second scanning terminal, providing, by the third control sub-circuit, the signal of the ground terminal to the third node, and storing a voltage difference between the first node and the third node.

In some possible implementations, the node control sub-circuit includes: a first control sub-circuit, a second control sub-circuit and a third control sub-circuit; when the node control sub-circuit provides the signal of the ground terminal to the second node and the third node, providing, by the node control sub-circuit, the signal of the initial signal terminal to the first node under control of the reset signal terminal, providing, by the node control sub-circuit, the signal of the data signal terminal to the second node under control of the first scanning terminal, and providing, by the node control sub-circuit, the signal of the ground terminal to the second node or providing the signal of the ground terminal to the second node and the third node under control of the second scanning terminal, includes: providing, by the first control sub-circuit, the signal of the initial signal terminal to the first node under control of the reset signal terminal; under control of the first scanning terminal, providing, by the second control sub-circuit, the signal of the data signal terminal to the second node, and storing a voltage difference between the second node and the ground terminal, and providing, by the second control sub-circuit, the signal of the ground terminal to the second node under the control of the second scanning terminal; under the control of the second scanning terminal, providing, by the third control sub-circuit, the signal of the ground terminal to the third node, and storing a voltage difference between the first node and the third node.

Other aspects will become apparent upon reading and understanding the drawings and detailed description.

### BRIEF DESCRIPTION OF DRAWINGS

Accompanying drawings are used for providing a understanding of technical solutions of the present disclosure and form a part of the specification. Together with embodiments of the present disclosure, the accompanying drawings are used for explaining technical solutions of the present disclosure, and do not constitute a limitation on the technical solutions of the present disclosure.

FIG. 1 is a schematic structural diagram of a pixel circuit according to an embodiment of the present disclosure.

FIG. 2 is an equivalent circuit diagram of a driving sub-circuit according to an exemplary embodiment.

FIG. 3 is a schematic structural diagram of a node control sub-circuit according to an exemplary embodiment.

FIG. 4 is a schematic structural diagram of a node control sub-circuit according to another exemplary embodiment.

FIG. 5 is an equivalent circuit diagram of a node control sub-circuit corresponding to FIG. 3.

FIG. 6 is an equivalent circuit diagram of a node control sub-circuit corresponding to FIG. 4.

FIG. 7 is an equivalent circuit diagram of a light emitting control sub-circuit according to an exemplary embodiment.

FIG. 8 is an equivalent circuit diagram of a pixel circuit according to an exemplary embodiment.

FIG. 9 is an equivalent circuit diagram of a pixel circuit according to another exemplary embodiment.

FIG. 10 is a working timing diagram of the pixel circuit provided in FIG. 8.

FIG. 11A is a working state diagram of the pixel circuit provided in FIG. 8 at an initialization stage.

FIG. 11B is a working state diagram of the pixel circuit provided in FIG. 8 at a compensation stage.

FIG. 11C is a working state diagram of the pixel circuit provided in FIG. 8 at a writing stage.

FIG. 11D is a working state diagram of the pixel circuit provided in FIG. 8 at a light emitting stage.

FIG. 12 is a working timing diagram of the pixel circuit provided in FIG. 9.

FIG. 13A is a working state diagram of the pixel circuit provided in FIG. 9 at an initialization stage.

FIG. 13B is a working state diagram of the pixel circuit provided in FIG. 9 at a compensation stage.

FIG. 13C is a working state diagram of the pixel circuit provided in FIG. 9 at a writing stage.

FIG. 13D is a working state diagram of the pixel circuit provided in FIG. 9 at a light emitting stage.

FIG. 14 is a flowchart of a method for driving a pixel circuit according to an embodiment of the present disclosure.

### DETAILED DESCRIPTION

Hereinafter, embodiments of the present disclosure will be described in detail with reference to the accompanying drawings. Without conflict, embodiments in the present disclosure and features in the embodiments may be combined with each other arbitrarily.

The present disclosure describes multiple embodiments, but the description is exemplary rather than limiting, and for those of ordinary skill in the art, there may be more embodiments and implementation solutions within the scope of the embodiments described in the present disclosure. Although many possible combinations of features are shown in the drawings, and discussed in the specific embodiments, many other combinations of the disclosed features are also possible. Unless specifically restricted, any feature or element of any embodiment may be used in combination with or in place of any other feature or element of any other embodiment.

The present disclosure includes and contemplates combinations with features and elements known to those of ordinary skill in the art. Embodiments, features and elements already disclosed in the present disclosure may also be combined with any conventional features or elements to form a technical solution defined by the claims. Any feature or element of any embodiment may also be combined with features or elements from other technical solutions to form another technical solution defined by the claims. Therefore, it should be understood that any of the features shown and discussed in the present disclosure may be implemented individually or in any suitable combination. Therefore, the embodiments are not limited except by the limitations according to the appended claims and their equivalents. In addition, various modifications and changes may be made within the protection scope of the appended claims.

Unless otherwise defined, technical terms or scientific terms used in the present disclosure shall have the general meaning understood by those with ordinary skills in the field to which the present disclosure pertains. The words “first”, “second” and the like used in the present disclosure do not indicate any order, quantity or importance, but are only used for distinguishing different components. Similar words such as “including” or “containing” mean that the elements or articles appearing before the word cover elements or the articles listed after the word and their equivalents, and do not exclude other elements or articles. Similar words such as “connecting” or “connected” are not limited to physical or mechanical connections, but may include electrical connections, no matter direct or indirect.

Both the switching transistor and the driving transistor used in the present disclosure may be thin film transistors, or may be field effect transistors or other devices with same characteristics. In an exemplary embodiment, a thin film transistor may be an oxide semiconductor transistor. Since a source and a drain of the switching transistor used in the present disclosure are symmetrical, the source and the drain thereof may be interchanged. In the present disclosure, a gate of a transistor is referred to as a control electrode, and in order to distinguish two electrodes of the transistor except the gate, one of the electrodes is referred to as a first electrode, and the other electrode is referred to as a second electrode. The first electrode may be a source or a drain, and the second electrode may be a drain or a source. The double-gate transistor includes two gates, and the two gate electrodes are referred to as a first control electrode and a second control electrode respectively in the present disclosure.

Generally, a current output by a driving transistor in an OLED display is related to a threshold voltage of the driving transistor itself. Drifting of the threshold voltage of the driving transistor will occur due to causes such as a process for the driving transistor and aging of a device, etc., such that a current flowing through OLED is different, resulting in an uneven display brightness and affecting the display effect.

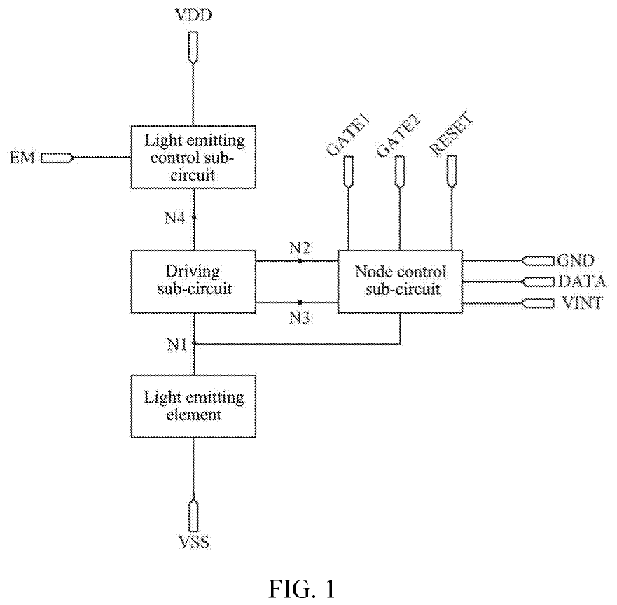

FIG. 1 is a schematic structural diagram of a pixel circuit according to an embodiment of the present disclosure. As shown in FIG. 1, the pixel circuit according to an embodiment of the present disclosure is configured to drive a light emitting element to emit light, the pixel circuit includes: a node control sub-circuit, a light emitting control sub-circuit and a driving sub-circuit.

The node control sub-circuit is connected with a first scanning terminal GATE1, a second scanning terminal GATE2, a reset signal terminal RESET, an initial signal terminal VINT, a first node N1, a second node N2, a third node N3, a data signal terminal DATA and a ground terminal GND, respectively, and is configured to provide a signal of the initial signal terminal VINT to the first node N1 under control of the reset signal terminal RESET, provide a signal of the data signal terminal DATA to the second node N2 under control of the first scanning terminal GATE1, and provide a signal of the ground terminal GND to the second node N2 or provide a signal of the ground terminal GND to the second node N2 and the third node N3 under control of the second scanning terminal GATE2. The light emitting control sub-circuit is connected with a first power supply terminal VDD, a light emitting control terminal EM and a fourth node N4 respectively, and is configured to provide a signal of the first power supply terminal VDD to the fourth node N4 under control of the light emitting control terminal EM. The driving sub-circuit is connected with the first node N1, the second node N2, the third node N3 and the fourth node N4 respectively, and is configured to provide a driving current to the first node N1 under control of the second node N2, the third node N3 and the fourth node N4.

The light emitting element is connected with the first node N1 and a second power supply terminal VSS respectively.

In an exemplary embodiment, the first power supply terminal VDD continuously provides a high-level signal, and the initial signal terminal VINT, the second power supply terminal VSS, and the ground terminal GND continuously provide low-level signals.

In an exemplary embodiment, signals of the first scanning terminal GATE1, the second scanning terminal GATE2, and the reset signal terminal RESET are pulse signals.

In an exemplary embodiment, a voltage value of the signal of the ground terminal GND is 0V.

The pixel circuit provided by the present disclosure is configured to drive a light emitting element to emit light, and includes: a node control sub-circuit, connected with a first scanning terminal, a second scanning terminal, a reset signal terminal, an initial signal terminal, a first node, a second node, a third node, a data signal terminal and a ground terminal respectively, and configured to provide a signal of the initial signal terminal to the first node under control of the reset signal terminal, provide a signal of the data signal terminal to the second node under control of the first scanning terminal, and provide a signal of the ground terminal to the second node or provide a signal of the ground terminal to the second node and the third node under control of the second scanning terminal; a light emitting control sub-circuit, connected with a first power supply terminal, a light emitting control terminal and a fourth node respectively, and configured to provide a signal of the first power supply terminal to the fourth node under control of the light emitting control terminal; a driving sub-circuit, connected with the first node, the second node, the third node and the fourth node respectively, and configured to provide a driving current to the first node under control of the second node, the third node and the fourth node; and a light emitting element, connected with the first node and a second power supply terminal respectively. According to the present disclosure, through cooperation among the node control sub-circuit, the light emitting control sub-circuit and the driving sub-circuit, a driving current flowing through the OLED may be made to be irrelevant to the threshold voltage, so that the display brightness is uniform, and the display effect is further improved.

In an exemplary embodiment, the light emitting element may be an organic light emitting diode OLED. An anode of the organic light emitting diode OLED is connected with the first node N1, and a cathode of the organic light emitting diode OLED is connected with the second power supply terminal VSS.

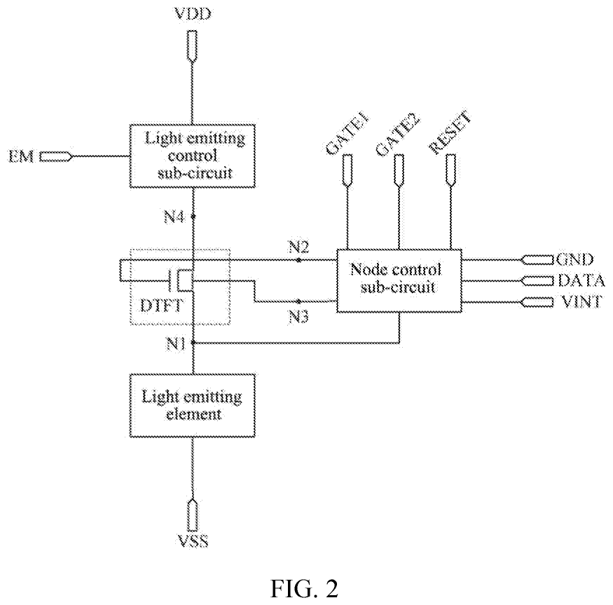

FIG. 2 is an equivalent circuit diagram of a driving sub-circuit according to an exemplary embodiment. As shown in FIG. 2, a driving sub-circuit in a pixel circuit according to an exemplary embodiment includes: a driving transistor DTFT, wherein the driving transistor DTFT is a double-gate transistor.

A first control electrode of the double-gate transistor is connected with a second node N2, a second control electrode of the double-gate transistor is connected with a third node N3, a first electrode of the double-gate transistor is connected with a fourth node N4, and a second electrode of the double-gate transistor is connected with a first node N1.

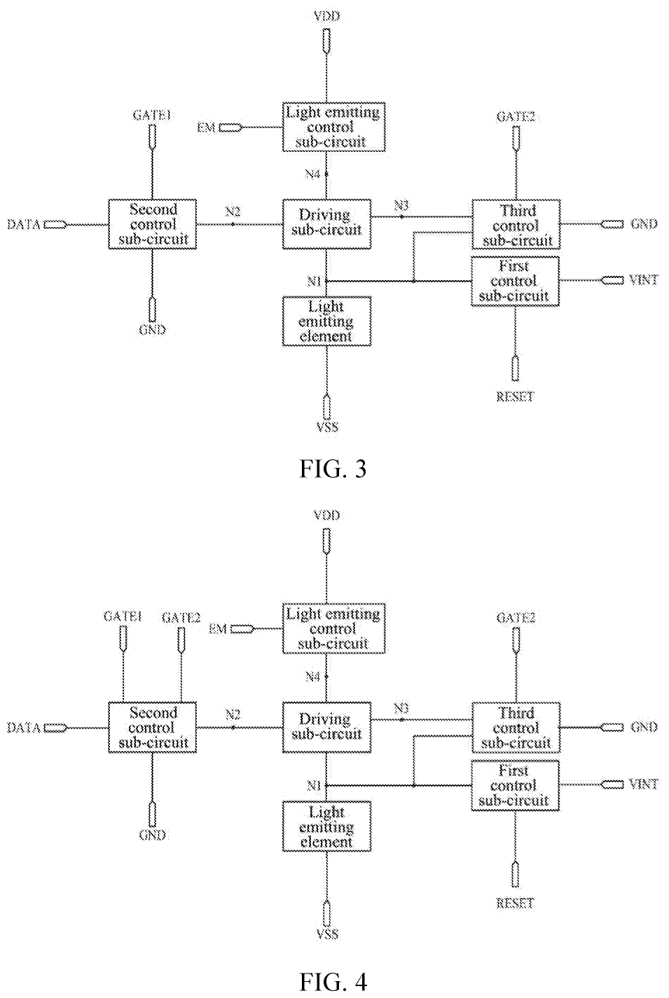

FIG. 3 is a schematic structural diagram of a node control sub-circuit according to an exemplary embodiment. As shown in FIG. 3, a node control sub-circuit in a pixel circuit according to an exemplary embodiment includes: a first control sub-circuit, a second control sub-circuit and a third control sub-circuit.

The first control sub-circuit is connected with a reset signal terminal RESET, an initial signal terminal VINT and a first node N1 respectively, and is configured to provide a signal of the initial signal terminal VINT to the first node N1 under control of the reset signal terminal RESET. The second control sub-circuit is connected with a first scanning terminal GATE1, a data signal terminal DATA, a ground terminal GND and a second node N2 respectively, and is configured to, under control of the first scanning terminal GATE1, provide a signal of the data signal terminal DATA to the second node N2, and store a voltage difference between the second node N2 and the ground terminal GND. The third control sub-circuit is connected with a second scanning terminal GATE2, the ground terminal GND, a third node N3 and the first node N1 respectively, and is configured to, under control of the second scanning terminal GATE2, provide a signal of the ground terminal GND to the third node N3, and store a voltage difference between the first node N1 and the third node N3.

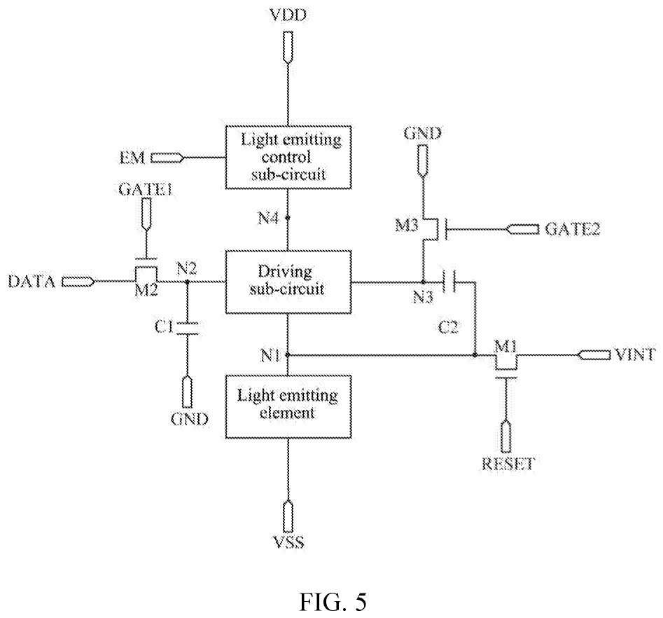

FIG. 4 is a schematic structural diagram of a node control sub-circuit according to another exemplary embodiment. As shown in FIG. 4, the node control sub-circuit shown in FIG. 4 is the same as the first control sub-circuit and the third control sub-circuit in the node control sub-circuit shown in FIG. 3, and is different from the second control sub-circuit. Compared with the second control sub-circuit shown in FIG. 3, the second control sub-circuit shown in FIG. 4 is also connected with a second scanning terminal GATE2, and is configured to provide a signal of a ground terminal GND to a second node N2 under control of the second scanning terminal GATE2.

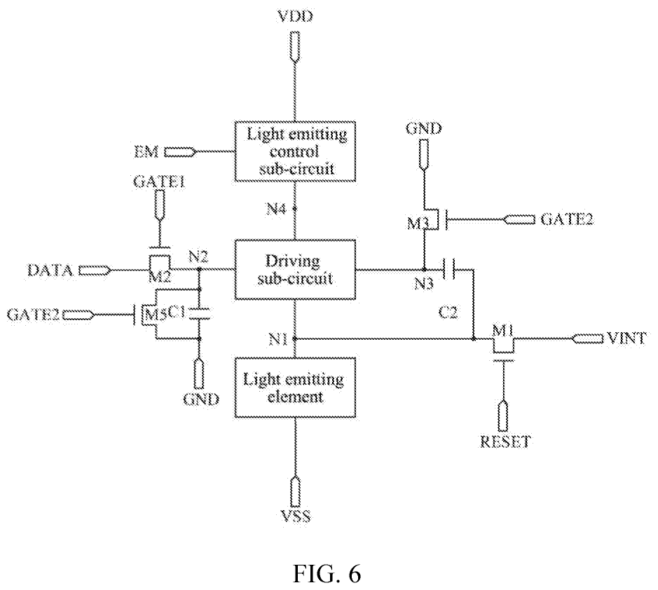

FIG. 5 is an equivalent circuit diagram of a node control sub-circuit corresponding to FIG. 3. As shown in FIG. 5, in an exemplary embodiment, a first control sub-circuit includes: a first switching transistor M1.

A control electrode of the first switching transistor M1 is connected with a reset signal terminal RESET, a first electrode of the first switching transistor M1 is connected with an initial signal terminal VINT, and a second electrode of the first switching transistor M1 is connected with a first node N1.

As shown in FIG. 5, in an exemplary embodiment, a second control sub-circuit includes: a second switching transistor M2 and a first capacitor C1.

A control electrode of the second switching transistor M2 is connected with a first scanning terminal GATE1, a first electrode of the second switching transistor M2 is connected with a data signal terminal DATA, and a second electrode of the second switching transistor M2 is connected with a second node N2. A first terminal of the first capacitor C1 is connected with the second node N2, and a second terminal of the first capacitor C1 is connected with a ground terminal GND.

As shown in FIG. 5, in an exemplary embodiment, a third control sub-circuit includes: a third switching transistor M3 and a second capacitor C2.

A control electrode of the third switching transistor M3 is connected with a second scanning terminal GATE2, a first electrode of the third switching transistor M3 is connected with the ground terminal GND, and a second electrode of the third switching transistor M3 is connected with a third node N3. A first terminal of the second capacitor C2 is connected with the third node N3, and a second terminal of the second capacitor C2 is connected with a first node N1.

FIG. 5 shows an exemplary structure of a node control sub-circuit, and an implementation of the node control sub-circuit is not limited thereto.

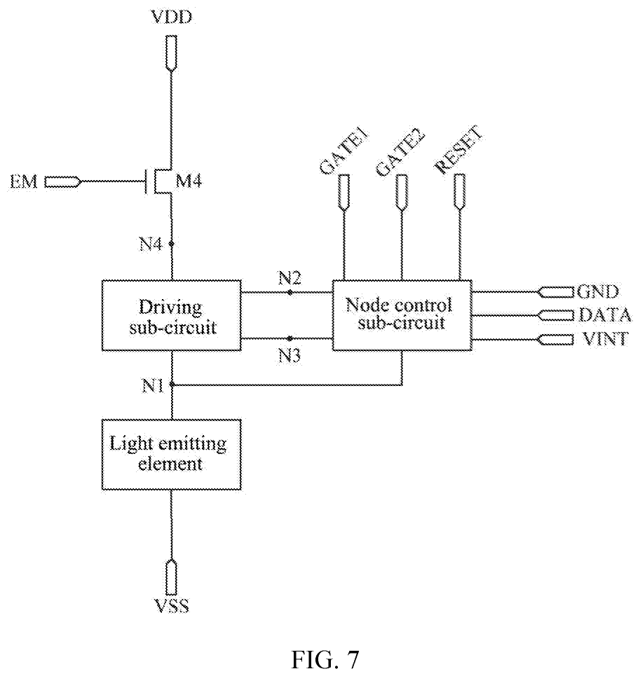

FIG. 6 is an equivalent circuit diagram of a node control sub-circuit corresponding to FIG. 4. As shown in FIG. 6, comparing FIG. 5 with FIG. 6, the first control sub-circuits in FIG. 5 and FIG. 6 are the same, and the third control sub-circuits in FIG. 5 and FIG. 6 are the same, and the difference is that, the second control sub-circuit in FIG. 6 includes: a second switching transistor M2, a first capacitor C1 and a fifth switching transistor M5.

A control electrode of the second switching transistor M2 is connected with a first scanning terminal GATE1, a first electrode of the second switching transistor M2 is connected with a data signal terminal DATA, and a second electrode of the second switching transistor M2 is connected with a second node N2. A first terminal of the first capacitor C1 is connected with the second node N2, and a second terminal of the first capacitor C1 is connected with a ground terminal GND. A control electrode of a fifth switching transistor M5 is connected with a second scanning terminal GATE2, a first electrode of the fifth switching transistor M5 is connected with the ground terminal GND, and a second electrode of the fifth switching transistor M5 is connected with the second node N2.

Another exemplary structure of the node control sub-circuit is shown in FIG. 6, and an implementation of the node control sub-circuit is not limited thereto.

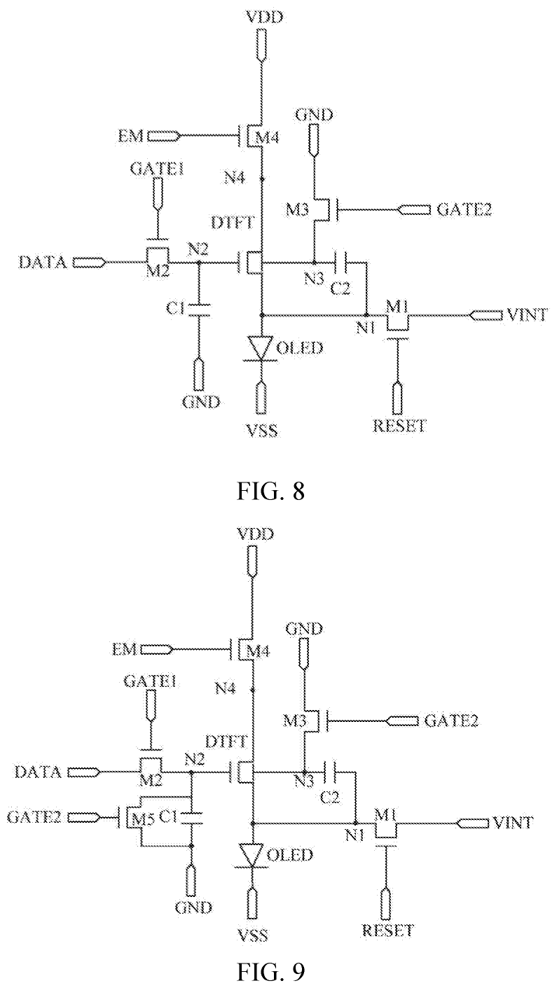

FIG. 7 is an equivalent circuit diagram of a light emitting control sub-circuit according to an exemplary embodiment. As shown in FIG. 7, a light emitting control sub-circuit in a pixel circuit according to an exemplary embodiment includes: a fourth switching transistor M4.

A control electrode of the fourth switching transistor M4 is connected with a light emitting control terminal EM, a first electrode of the fourth switching transistor M4 is connected with a first power supply terminal VDD, and a second electrode of the fourth switching transistor M4 is connected with a fourth node N4.

An exemplary structure of the light emitting control sub-circuit is shown in FIG. 7, and an implementation of the light emitting control sub-circuit is not limited thereto.

In an exemplary embodiment, a voltage value of a signal of the first power supply terminal VDD is greater than a voltage value of a signal of a second power supply terminal VSS.

In an exemplary embodiment, a voltage value of a signal of a data signal terminal DATA includes: a first voltage value and a second voltage value; the first voltage value is less than the second voltage value. The first voltage value is the same as a voltage value of a signal of a ground terminal GND.

In an exemplary embodiment, a voltage value of a signal of an initial signal terminal VINT is less than a voltage value of a signal of a second power supply terminal VSS, which may ensure normal display of a light emitting element.

In an exemplary embodiment, a voltage value of a signal of an initial signal terminal VINT is less than a difference between a voltage value of a signal of a ground terminal GND and a threshold voltage of a driving transistor DTFT. For example, the threshold voltage of the driving transistor DTFT is 2V, and the voltage value of the signal of the initial signal terminal VINT is less than −2V, and may be −3V.

In an exemplary embodiment, switching transistors M1 to M5 may be single-gate transistors.

The driving transistor DTFT and the switching transistors M1 to M5 may all be of N-type or may all be of P-type. The driving transistor DTFT and the switching transistors M1 to M5 are of a same transistor type, which may unify a process flow, reduce a process, and improve yield of display products.

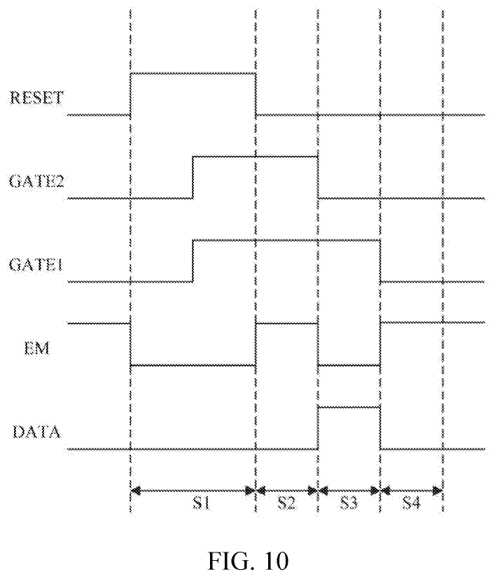

FIG. 8 is an equivalent circuit diagram of a pixel circuit according to an exemplary embodiment. As shown in FIG. 8, in an exemplary embodiment, a node control sub-circuit includes: a first switching transistor M1, a second switching transistor M2, a third switching transistor M3, a first capacitor C1, and a second capacitor C2. A light emitting control sub-circuit includes: a fourth switching transistor M4. A driving sub-circuit includes: a driving transistor DTFT.

A control electrode of the first switching transistor M1 is connected with a reset signal terminal RESET, a first electrode of the first switching transistor M1 is connected with an initial signal terminal VINT, and a second electrode of the first switching transistor M1 is connected with a first node N1. A control electrode of the second switching transistor M2 is connected with a first scanning terminal GATE1, a first electrode of the second switching transistor M2 is connected with a data signal terminal DATA, and a second electrode of the second switching transistor M2 is connected with a second node N2. A first terminal of the first capacitor C1 is connected with the second node N2, and a second terminal of the first capacitor C1 is connected with a ground terminal GND. A control electrode of the third switching transistor M3 is connected with a second scanning terminal GATE2, a first electrode of the third switching transistor M3 is connected with the ground terminal GND, and a second electrode of the third switching transistor M3 is connected with a third node N3. A first terminal of the second capacitor C2 is connected with the third node N3, and a second terminal of the second capacitor C2 is connected with a first node N1. A control electrode of the fourth switching transistor M4 is connected with a light emitting control terminal EM, a first electrode of the fourth switching transistor M4 is connected with a first power supply terminal VDD, and a second electrode of the fourth switching transistor M4 is connected with a fourth node N4. The driving transistor DTFT is a double-gate transistor, wherein a first control electrode of the double-gate transistor is connected with the second node N2, a second control electrode of the double-gate transistor is connected with the third node N3, a first electrode of the double-gate transistor is connected with the fourth node N4, and a second electrode of the double-gate transistor is connected with the first node N1.

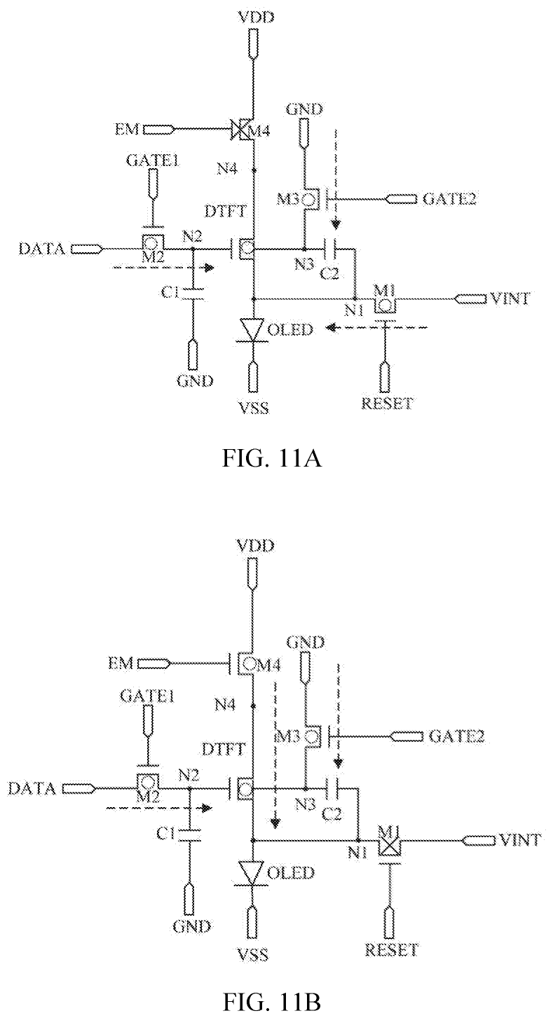

FIG. 9 is an equivalent circuit diagram of a pixel circuit according to another exemplary embodiment. As shown in FIG. 9, in an exemplary embodiment, a node control sub-circuit includes: a first switching transistor M1, a second switching transistor M2, a third switching transistor M3, a fifth switching transistor M5, a first capacitor C1, and a second capacitor C2. A light emitting control sub-circuit includes: a fourth switching transistor M4. A driving sub-circuit includes: a driving transistor DTFT.

A control electrode of the first switching transistor M1 is connected with a reset signal terminal RESET, a first electrode of the first switching transistor M1 is connected with an initial signal terminal VINT, and a second electrode of the first switching transistor M1 is connected with a first node N1. A control electrode of the second switching transistor M2 is connected with a first scanning terminal GATE1, a first electrode of the second switching transistor M2 is connected with a data signal terminal DATA, and a second electrode of the second switching transistor M2 is connected with a second node N2. A first terminal of the first capacitor C1 is connected with the second node N2, and a second terminal of the first capacitor C1 is connected with a ground terminal GND. A control electrode of the third switching transistor M3 is connected with a second scanning terminal GATE2, a first electrode of the third switching transistor M3 is connected with the ground terminal GND, and a second electrode of the third switching transistor M3 is connected with a third node N3. A first terminal of the second capacitor C2 is connected with the third node N3, and a second terminal of the second capacitor C2 is connected with a first node N1. A control electrode of the fourth switching transistor M4 is connected with a light emitting control terminal EM, a first electrode of the fourth switching transistor M4 is connected with a first power supply terminal VDD, and a second electrode of the fourth switching transistor M4 is connected with a fourth node N4. A control electrode of a fifth switching transistor M5 is connected with a second scanning terminal GATE2, a first electrode of the fifth switching transistor M5 is connected with the ground terminal GND, and a second electrode of the fifth switching transistor M5 is connected with the second node N2. The driving transistor DTFT is a double-gate transistor, wherein a first control electrode of the double-gate transistor is connected with the second node N2, a second control electrode of the double-gate transistor is connected with the third node N3, a first electrode of the double-gate transistor is connected with the fourth node N4, and a second electrode of the double-gate transistor is connected with the first node N1.

In the following, a pixel circuit of an exemplary embodiment will be explained by a working process of a pixel circuit provided in FIG. 8.

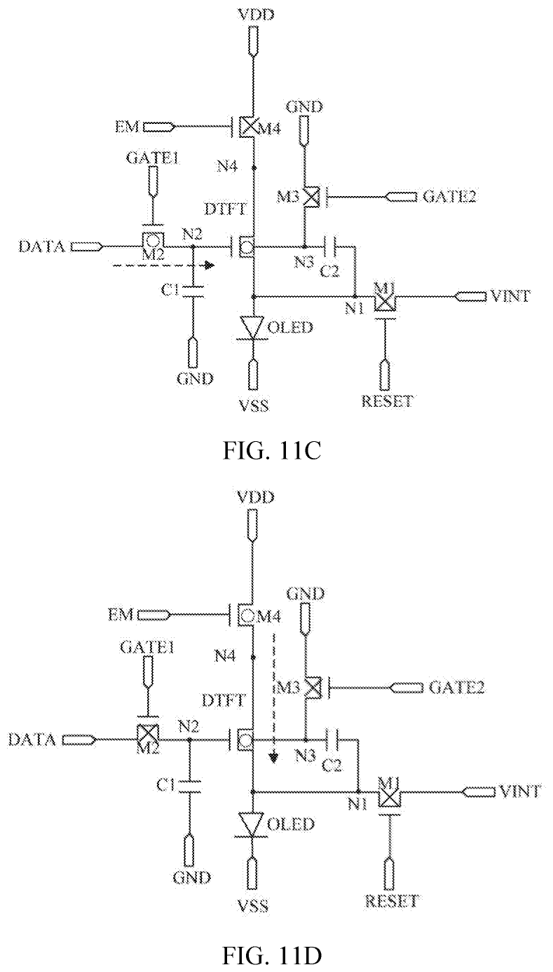

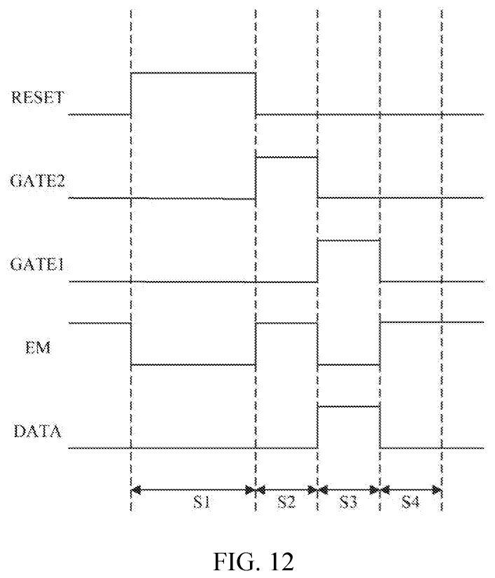

Taking switching transistors M1 to M4 in the pixel circuit provided in FIG. 8 being all N-type thin film transistors as an example, FIG. 10 is a working timing chart of the pixel circuit provided in FIG. 8; FIG. 11A is a working state diagram of the pixel circuit provided in FIG. 8 at an initialization stage, FIG. 11B is a working state diagram of the pixel circuit provided in FIG. 8 at a compensation stage, FIG. 11C is a working state diagram of the pixel circuit provided in FIG. 8 at a writing stage, and FIG. 11D is a working state diagram of the pixel circuit provided in FIG. 8 at a light emitting stage. As shown in FIGS. 8, 10, and 11, a pixel circuit in an exemplary embodiment includes: four switching transistors (M1 to M4), one driving transistor (DTFT), two capacitance units (C1 and C2), six signal input terminals (DATA, GATE1, GATE2, EM, VINT, and RESET), and three power supply terminals (VDD, VSS, and GND).

The first power supply terminal VDD continuously provides a high-level signal, and an initial signal terminal VINT, a second power supply terminal VSS, and a ground terminal GND continuously provide low-level signals.

In a first stage S1, i.e. an initialization stage, as shown in FIG. 11A, a signal of the reset signal terminal RESET is at a high level, the first switching transistor M1 is turned on, and a potential of a first node N1 is pulled down by a signal of the initial signal terminal VINT. At this time, a voltage value V1 of the first node N1=Vint, wherein Vint is a voltage value of the signal of the initial signal terminal VINT. A signal of the first scanning terminal GATE1 is at a high level, the second switching transistor M2 is turned on, and a potential of a second node N2 is pulled down by the signal of the data signal terminal DATA. A voltage value of the signal of the data signal terminal DATA is a first voltage value, wherein the first voltage value is equal to a voltage value of the signal of the ground terminal GND. At this time, a voltage value V2 of the second node N2=0V. A signal of the second scanning terminal GATE2 is at a high level, the third switching transistor M3 is turned on, and a potential of a third node N3 is pulled down by the signal of the ground terminal GND. At this time, a voltage value V3 of the third node N3=0V. Since Vint is less than a voltage difference between the voltage value of the signal of the ground terminal GND and the threshold voltage Vth of the driving transistor DTFT, a gate-source voltage difference V2+V3−V1 of the driving transistor DTFT is greater than the threshold voltage Vth of the driving transistor DTFT. At this time, the driving transistor DTFT is turned on.

In a second stage S2, i.e. a compensation stage, as shown in FIG. 11B, the signal of the first scanning terminal GATE1 is at the high level, the second switching transistor M2 is turned on, and the potential of a second node N2 is pulled down by the signal of the data signal terminal DATA. Since the voltage value of the signal of the data signal terminal DATA is the first voltage value, wherein the first voltage value is equal to the voltage value of the signal of the ground terminal GND, at this time, the voltage value V2 of the second node N2=0V. The signal of the second scanning terminal GATE2 is at the high level, the third switching transistor M3 is turned on, and the potential of the third node N3 is continuously pulled down by the signal of the ground terminal GND. At this time, the voltage value V3 of the third node N3=0V. A signal of the light emitting control terminal EM is at a high level, and the fourth switching transistor M4 is turned on. Since the driving transistor DTFT is turned on, the first power supply terminal VDD charges the first node N1 until the voltage value V1 of the first node N1=−Vth. At this time, since a gate-source voltage difference V2+V3−V1 of the driving transistor DTFT is equal to Vth, the driving transistor DTFT is turned off.

In a third stage S3, i.e. a writing stage, as shown in FIG. 11C, the signal of the first scanning terminal GATE1 is at the high level, the signal of the data signal terminal DATA is at a high level, and the signal of the data signal terminal DATA is provided to the second node N2. At this time, the voltage value V2 of the second node N2=Vdata, wherein a voltage value of the signal of the data signal terminal DATA is a second voltage value, and the second voltage value is equal to Vdata. In this stage, V1=−Vth, and V3=0V. Since the gate-source voltage difference V2+V3−V1 of the driving transistor DTFT is greater than Vth, the driving transistor DTFT is turned on.

In a fourth stage S4, i.e. a light emitting stage, as shown in FIG. 11D, the signal of the light emitting control terminal EM is at the high level, and the fourth switching transistor M4 is turned on. Since the driving transistor DTFT is turned on, the first power supply terminal VDD charges the first node N1 until the voltage value V1 of the first node N1=Voled. At this time, V2=Vdata, and V3=Voled+Vth due to a coupling role of the second capacitor C2.

According to a current formula when the driving transistor DTFT is saturated, it may be obtained that, a driving current I_{OLED} flowing through a light emitting element meets:

$$\begin{matrix}{I}_{OLED} = {K ( {V}_{GS} - Vth )}^{2} \\ = {K ( V 2 + V 3 - V 1 - Vth )}^{2} \\ = {K ( Vdata + Voled + Vth - Voled - Vth )}^{2} \\ = {K ( Vdata )}^{2}\end{matrix}$$

K is a fixed constant related to a process parameter and a geometric dimension of the driving transistor DTFT, V_{GS} is a gate-source voltage difference of the driving transistor DFTF, and Vth is the threshold voltage of the driving transistor DFTF.

From a derivation result of the above current formula, it may be seen that at the light emitting stage, a driving current output by the driving transistor DTFT has not been affected by the threshold voltage of the driving transistor DTFT, but is only related to the signal on the data signal terminal, an effect of the threshold voltage of the driving transistor DTFT on the driving current is eliminated, and a uniform display brightness may be ensured, the display effect is improved.

In the following, a pixel circuit of an exemplary embodiment will be explained by a working process of a pixel circuit provided in FIG. 9.

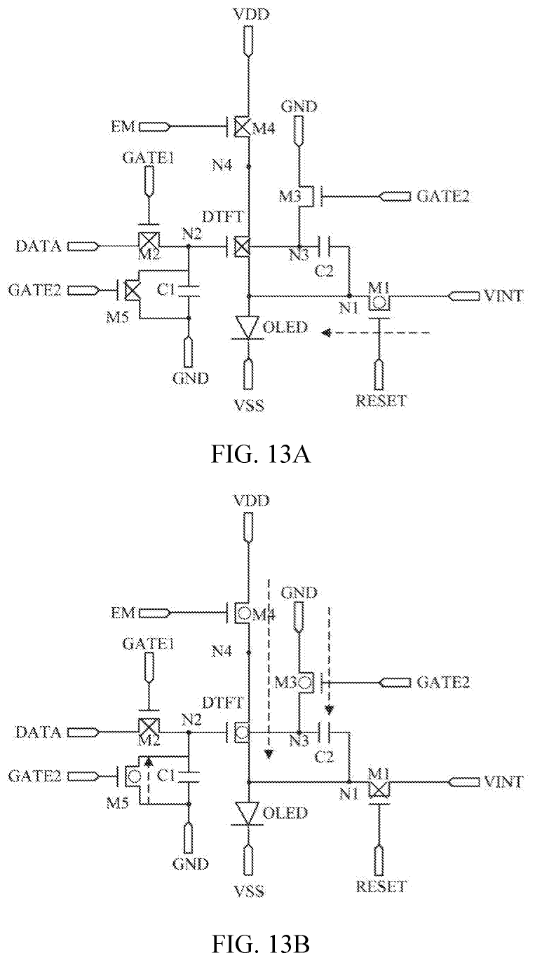

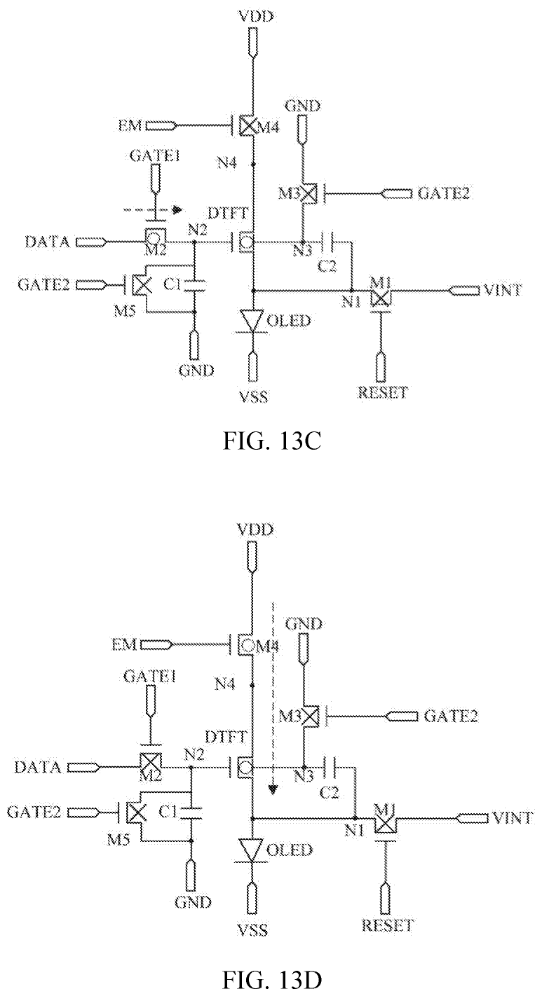

Taking switching transistors M1 to M5 in the pixel circuit provided in FIG. 9 being all N-type thin film transistors as an example, FIG. 12 is a working timing diagram of the pixel circuit provided in FIG. 9; FIG. 13A is a working state diagram of the pixel circuit provided in FIG. 9 at an initialization stage, FIG. 13B is a working state diagram of the pixel circuit provided in FIG. 9 at a compensation stage, FIG. 13C is a working state diagram of the pixel circuit provided in FIG. 9 at a writing stage, and FIG. 13D is a working state diagram of the pixel circuit provided in FIG. 9 at a light emitting stage. As shown in FIGS. 9, 12, and 13, a pixel circuit in an exemplary embodiment includes: five switching transistors (M1 to M5), one driving transistor (DTFT), two capacitance units (C1 and C2), six signal input terminals (DATA, GATE1, GATE2, EM, VINT, and RESET), and three power supply terminals (VDD, VSS, and GND).

The first power supply terminal VDD continuously provides a high-level signal, and an initial signal terminal VINT, the second power supply terminal VSS, and the ground terminal GND continuously provide low-level signals.

In a first stage S1, i.e. an initialization stage, as shown in FIG. 13A, a signal of the reset signal terminal RESET is at a high level, the first switching transistor M1 is turned on, and a potential of a first node N1 is pulled down by a signal of the initial signal terminal VINT. At this time, a voltage value V1 of the first node N1=Vint, wherein Vint is a voltage value of an input signal of the initial signal terminal VINT.

In a second stage S2, i.e. a compensation stage, as shown in FIG. 13B, a signal of a second scanning terminal GATE2 is at a high level, the third switching transistor M3 is turned on, and a potential of a third node N3 is continuously pulled down by a signal of the ground terminal GND. At this time, a voltage value V3 of the third node N3=0V. The signal of the second scanning terminal GATE2 is at the high level, the fifth switching transistor M5 is turned on, and a potential of a second node N2 is pulled down by the signal of the ground terminal GND. At this time, a voltage value V2 of the second node N2 is 0V. When the stage starts, the voltage value V1 of the first node N1=Vint. Since a gate-source voltage difference V2+V3−V1 of the driving transistor DTFT is greater than Vth, the driving transistor DTFT is turned on. A signal of the light emitting control terminal EM is at a high level, and the fourth switching transistor M4 is turned on. Since the driving transistor DTFT is turned on, the first power supply terminal VDD charges the first node N1 until the voltage value V1 of the first node N1=−Vth, the driving transistor DTFT is turned off.

In a third stage S3, i.e. a writing stage, as shown in FIG. 13C, a signal of a first scanning terminal GATE1 is at a high level, a signal of a data signal terminal Data is at a high level, and an input signal of the data signal terminal Data is provided to the second node N2. At this time, the voltage value V2 of the second node N2=Vdata, wherein a voltage value of the signal of the data signal terminal DATA is a second voltage value, and the second voltage value is equal to Vdata. In this stage, V1=−Vth, and V3=0V. Since the gate-source voltage difference V2+V3−V1 of the driving transistor DTFT is greater than Vth, the driving transistor DTFT is turned on.

In a fourth stage S4, i.e. a light emitting stage, as shown in FIG. 13D, an input signal of the light emitting control terminal EM is at a high level, and the fourth switching transistor M4 is turned on. Since the driving transistor DTFT is turned on, the first power supply terminal VDD charges the first node N1 until the voltage value V1 of the first node N1=Voled. At this time, V2=Vdata, and V3=Voled+Vth due to a coupling role of the second capacitor C2.

According to a current formula when the driving transistor DTFT is saturated, it may be obtained that, a driving current I_{OLED} flowing through a light emitting element meets:

$$\begin{matrix}{I}_{OLED} = {K ( {V}_{GS} - Vth )}^{2} \\ = {K ( V 2 + V 3 - V 1 - Vth )}^{2} \\ = {K ( Vdata + Voled + Vth - Voled - Vth )}^{2} \\ = {K ( Vdata )}^{2}\end{matrix}$$

K is a fixed constant related to a process parameter and a geometric dimension of the driving transistor DTFT, V_{GS} is a gate-source voltage difference of the driving transistor DFTF, and Vth is the threshold voltage of the driving transistor DFTF.

From a derivation result of the above current formula, it may be seen that at the light emitting stage, a driving current output by the driving transistor DTFT has not been affected by the threshold voltage of the driving transistor DTFT, but is only related to the signal on the data signal terminal, an effect of the threshold voltage of the driving transistor DTFT on the driving current is eliminated, and a uniform display brightness may be ensured, the display effect is improved.

The reset signal terminal RESET in the pixel circuit provided in FIG. 9 is at an effective level only in the initialization stage, the second scanning terminal GATE2 is at an effective level only in the compensation stage, and the first scanning terminal GATE1 is at an effective level only in the input stage. The reset signal terminal RESET, the second scanning terminal GATE2 and the first scanning terminal GATE1 may be respectively connected with three cascaded shift registers, signal lines of a pixel circuit may be reduced, realizing narrow borders.

In an exemplary embodiment, a voltage value of the signal of the data signal terminal DATA in the initialization stage, the compensation stage and the light emitting stage is a first voltage value, and a voltage value of the signal of the data signal terminal DATA in the writing stage is a second voltage value.

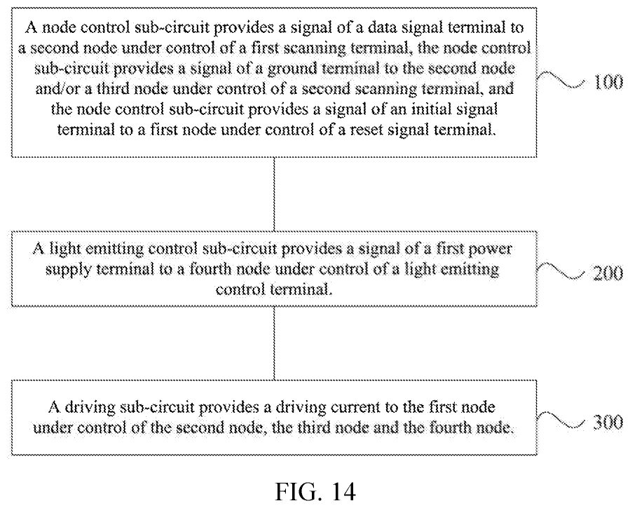

An embodiment of the present disclosure also provides a method for driving a pixel circuit, for driving the pixel circuit. FIG. 14 is a flowchart of a method for driving a pixel circuit according to an embodiment of the present disclosure. As shown in FIG. 14, the method for driving the pixel circuit according to an embodiment of the present disclosure includes following acts 100, 200, and 300.

In act 100, a node control sub-circuit provides a signal of an initial signal terminal to a first node under control of a reset signal terminal, the node control sub-circuit provides a signal of a data signal terminal to a second node under control of a first scanning terminal, and the node control sub-circuit provides a signal of a ground terminal to the second node or provides a signal of a ground terminal to the second node and a third node under control of a second scanning terminal.

In act 200, a light emitting control sub-circuit provides a signal of a first power supply terminal to a fourth node under control of a light emitting control terminal.

In act 300, a driving sub-circuit provides a driving current to the first node under control of the second node, the third node and the fourth node.

The pixel circuit is a pixel circuit provided in any of the previous embodiments, and its implementation principle and effect are similar to those of the previous one, which will not be repeated here.

In an exemplary embodiment, the node control sub-circuit includes: a first control sub-circuit, a second control sub-circuit and a third control sub-circuit. When the node control sub-circuit provides the signal of the ground terminal to the second node, act 100 includes: the first control sub-circuit provides the signal of the initial signal terminal to the first node under the control of the reset signal terminal; the second control sub-circuit, under the control of the first scanning terminal, provides the signal of the data signal terminal to the second node, and stores a voltage difference between the second node and the ground terminal; the third control sub-circuit, under the control of the second scanning terminal, provides the signal of the ground terminal to the third node, and stores a voltage difference between the first node and the third node.

In another exemplary embodiment, the node control sub-circuit includes: a first control sub-circuit, a second control sub-circuit and a third control sub-circuit. When the node control sub-circuit provides the signal of the ground terminal to the second node and the third node, the node control sub-circuit provides the signal of the initial signal terminal to the first node under the control of the reset signal terminal, the node control sub-circuit provides the signal of the data signal terminal to the second node under the control of the first scanning terminal, and the node control sub-circuit provides the signal of the ground terminal to the second node or provides the signal of the ground terminal to the second node and the third node under the control of the second scanning terminal, including: the first control sub-circuit provides the signal of the initial signal terminal to the first node under the control of the reset signal terminal; the second control sub-circuit, under the control of the first scanning terminal, provides the signal of the data signal terminal to the second node, and stores a voltage difference between the second node and the ground terminal, and the second control sub-circuit provides the signal of the ground terminal to the second node under the control of the second scanning terminal; the third control sub-circuit, under the control of the second scanning terminal, provides the signal of the ground terminal to the third node, and stores a voltage difference between the first node and the third node.

An embodiment of the present disclosure also provides a display apparatus. The display apparatus according to an embodiment of the present disclosure includes: a gate driving circuit and pixel circuits arranged in a matrix.

The gate driving circuit includes: N cascaded shift registers, wherein each stage of the shift registers includes an output terminal, and the output terminal of the N-th stage shift register is connected with first scanning terminals of an N-th row of the pixel circuits, and is configured to provide a gate driving signal to the first scanning terminals of the N-th row of the pixel circuits.

The pixel circuit is a pixel circuit provided in any of the previous embodiments, and its implementation principle and effect are similar to those of the previous one, which will not be repeated here.

In an exemplary embodiment, when a node control sub-circuit is configured to provide a signal of a ground terminal to a second node and a third node, the first scanning terminals of the N-th row of pixel circuits are connected with the output terminal of the N-th stage shift register, second scanning terminals of the N-th row of pixel circuits are connected with the output terminal of the (N−1)-th stage shift register, and reset signal terminals of the N-th row of pixel circuits are connected with the output terminal of the (N−2)-th stage shift register.

The drawings in the present disclosure only refer to the structures involved in embodiments of the present disclosure, and other structures may refer to common designs.

Although embodiments of the present disclosure are disclosed in the above, the said contents are only embodiments used for easily understanding the present disclosure, rather than restricting the present disclosure. Any person skilled in the art to which the present disclosure pertains may make any modifications and variations in forms and details of implementation without departing from the spirit and the scope disclosed in the present disclosure, but the patent protection scope of the present disclosure shall still be subject to the scope defined in the appended claims.

What is claimed is:

1. A pixel circuit, configured to drive a light emitting element to emit light, the pixel circuit comprising: a node control sub-circuit, a light emitting control sub-circuit and a driving sub-circuit; wherein,
the node control sub-circuit is connected with a first scanning terminal, a second scanning terminal, a reset signal terminal, an initial signal terminal, a first node, a second node, a third node, a data signal terminal and a ground terminal respectively, and is configured to provide a signal of the initial signal terminal to the first node under control of the reset signal terminal, provide a signal of the data signal terminal to the second node under control of the first scanning terminal, and provide a signal of the ground terminal to the second node or provide a signal of the ground terminal to the second node and the third node under control of the second scanning terminal;
the light emitting control sub-circuit is connected with the first power supply terminal, the light emitting control terminal and a fourth node respectively, and is configured to provide a signal of the first power supply terminal to the fourth node under control of the light emitting control terminal;
the driving sub-circuit is connected with the first node, the second node, the third node and the fourth node respectively, and is configured to provide a driving current to the first node under control of the second node, the third node and the fourth node;
the light emitting element is connected with the first node and the second power supply terminal respectively.

2. The pixel circuit according to claim 1, wherein the driving sub-circuit comprises: a driving transistor, wherein the driving transistor is a double-gate transistor;
a first control electrode of the double-gate transistor is connected with the second node, a second control electrode of the double-gate transistor is connected with the third node, a first electrode of the double-gate transistor is connected with the fourth node, and a second electrode of the double-gate transistor is connected with the first node.

3. The pixel circuit according to claim 1, wherein the light emitting element comprises: an organic light emitting diode;
an anode of the organic light emitting diode is connected with the first node, and a cathode of the organic light emitting diode is connected with the second power supply terminal.

4. The pixel circuit according to claim 1, wherein the node control sub-circuit comprises:
a first control sub-circuit, a second control sub-circuit and a third control sub-circuit;
the first control sub-circuit is connected with the reset signal terminal, the initial signal terminal and the first node respectively, and is configured to provide the signal of the initial signal terminal to the first node under the control of the reset signal terminal;
the second control sub-circuit is connected with the first scanning terminal, the data signal terminal, the ground terminal and the second node respectively, and is configured to, under the control of the first scanning terminal, provide the signal of the data signal terminal to the second node, and store a voltage difference between the second node and the ground terminal;
the third control sub-circuit is connected with the second scanning terminal, the ground terminal, the third node and the first node respectively, and is configured to, under the control of the second scanning terminal, provide the signal of the ground terminal to the third node, and store a voltage difference between the first node and the third node.

5. The pixel circuit according to claim 4, wherein the second control sub-circuit is further connected with the second scanning terminal, and is configured to provide the signal of the ground terminal to the second node under the control of the second scanning terminal.

6. The pixel circuit according to claim 4, wherein the first control sub-circuit comprises: a first switching transistor;
a control electrode of the first switching transistor is connected with the reset signal terminal, a first electrode of the first switching transistor is connected with the initial signal terminal, and a second electrode of the first switching transistor is connected with the first node.

7. The pixel circuit according to claim 4, wherein the second control sub-circuit comprises:
a second switching transistor and a first capacitor;
a control electrode of the second switching transistor is connected with the first scanning terminal, a first electrode of the second switching transistor is connected with the data signal terminal, and a second electrode of the second switching transistor is connected with the second node;
a first terminal of the first capacitor is connected with the second node, and a second terminal of the first capacitor is connected with the ground terminal.

8. The pixel circuit according to claim 4, wherein the third control sub-circuit comprises:
a third switching transistor and a second capacitor;
a control electrode of the third switching transistor is connected with the second scanning terminal, a first electrode of the third switching transistor is connected with the ground terminal, and a second electrode of the third switching transistor is connected with the third node;
a first terminal of the second capacitor is connected with the third node, and a second terminal of the second capacitor is connected with the first node.

9. The pixel circuit according to claim 5, wherein the second control sub-circuit comprises:
a second switching transistor, a first capacitor, and a fifth switching transistor;
a control electrode of the second switching transistor is connected with the first scanning terminal, a first electrode of the second switching transistor is connected with the data signal terminal, and a second electrode of the second switching transistor is connected with the second node;
a first terminal of the first capacitor is connected with the second node, and a second terminal of the first capacitor is connected with the ground terminal;
a control electrode of the fifth switching transistor is connected with the second scanning terminal, a first electrode of the fifth switching transistor is connected with the ground terminal, and a second electrode of the fifth switching transistor is connected with the second node.

10. The pixel circuit according to claim 1, wherein the light emitting control sub-circuit comprises: a fourth switching transistor;
a control electrode of the fourth switching transistor is connected with the light emitting control terminal, a first electrode of the fourth switching transistor is connected with the first power supply terminal, and a second electrode of the fourth switching transistor is connected with the fourth node.

11. The pixel circuit according to claim 1, wherein a voltage value of the signal of the data signal terminal comprises: a first voltage value and a second voltage value; the first voltage value is less than the second voltage value;
the first voltage value is same as a voltage value of the signal of the ground terminal.

12. The pixel circuit according to claim 2, wherein a voltage value of the signal of the initial signal terminal is less than a difference between a voltage value of the signal of the ground terminal and a threshold voltage of the driving transistor.

13. The pixel circuit according to claim 1, wherein a voltage value of the signal of the first power supply terminal is greater than a voltage value of the signal of the second power supply terminal;
a voltage value of the signal of the initial signal terminal is less than a voltage value of the signal of the second power supply terminal.

14. The pixel circuit according to claim 1, wherein the node control sub-circuit comprises:
a first switching transistor, a second switching transistor, a third switching transistor, a first capacitor and a second capacitor, the light emitting control sub-circuit comprises: a fourth switching transistor, and the driving sub-circuit comprises: a driving transistor;
a control electrode of the first switching transistor is connected with the reset signal terminal, a first electrode of the first switching transistor is connected with the initial signal terminal, and a second electrode of the first switching transistor is connected with the first node;
a control electrode of the second switching transistor is connected with the first scanning terminal, a first electrode of the second switching transistor is connected with the data signal terminal, and a second electrode of the second switching transistor is connected with the second node;
a first terminal of the first capacitor is connected with the second node, and a second terminal of the first capacitor is connected with the ground terminal;
a control electrode of the third switching transistor is connected with the second scanning terminal, a first electrode of the third switching transistor is connected with the ground terminal, and a second electrode of the third switching transistor is connected with the third node;
a first terminal of the second capacitor is connected with the third node, and a second terminal of the second capacitor is connected with the first node;
a control electrode of the fourth switching transistor is connected with the light emitting control terminal, a first electrode of the fourth switching transistor is connected with the first power supply terminal, and a second electrode of the fourth switching transistor is connected with the fourth node;
the driving transistor is a double-gate transistor, a first control electrode of the double-gate transistor is connected with the second node, a second control electrode of the double-gate transistor is connected with the third node, a first electrode of the double-gate transistor is connected with the fourth node, and a second electrode of the double-gate transistor is connected with the first node.

15. The pixel circuit according to claim 1, wherein the node control sub-circuit comprises: a first switching transistor, a second switching transistor, a third switching transistor, a fifth switching transistor, a first capacitor and a second capacitor, the light emitting control sub-circuit comprises: a fourth switching transistor, and the driving sub-circuit comprises: a driving transistor;
a control electrode of the first switching transistor is connected with the reset signal terminal, a first electrode of the first switching transistor is connected with the initial signal terminal, and a second electrode of the first switching transistor is connected with the first node;
a control electrode of the second switching transistor is connected with the first scanning terminal, a first electrode of the second switching transistor is connected with the data signal terminal, and a second electrode of the second switching transistor is connected with the second node;
a first terminal of the first capacitor is connected with the second node, and a second terminal of the first capacitor is connected with the ground terminal;
a control electrode of the third switching transistor is connected with the second scanning terminal, a first electrode of the third switching transistor is connected with the ground terminal, and a second electrode of the third switching transistor is connected with the third node;
a first terminal of the second capacitor is connected with the third node, and a second terminal of the second capacitor is connected with the first node;
a control electrode of the fourth switching transistor is connected with the light emitting control terminal, a first electrode of the fourth switching transistor is connected with the first power supply terminal, and a second electrode of the fourth switching transistor is connected with the fourth node;
a control electrode of the fifth switching transistor is connected with the second scanning terminal, a first electrode of the fifth switching transistor is connected with the ground terminal, and a second electrode of the fifth switching transistor is connected with the second node;
the driving transistor is a double-gate transistor, a first control electrode of the double-gate transistor is connected with the second node, a second control electrode of the double-gate transistor is connected with the third node, a first electrode of the double-gate transistor is connected with the fourth node, and a second electrode of the double-gate transistor is connected with the first node.

16. A display apparatus, comprising: a gate driving circuit and pixel circuits arranged in a matrix, the pixel circuits being pixel circuits according to claim 1;
the gate driving circuit comprising: N cascaded shift registers, each stage of the shift registers comprising an output terminal, and the output terminal of an N-th stage shift register being connected with first scanning terminals of an N-th row of the pixel circuits, and being configured to provide a gate driving signal to the first scanning terminals of the N-th row of the pixel circuits.

17. The apparatus according to claim 16, wherein when the node control sub-circuit is configured to provide a signal of a ground terminal to a second node and a third node, the first scanning terminals of the N-th row of the pixel circuits are connected with the output terminal of the N-th stage shift register, second scanning terminals of the N-th row of the pixel circuits are connected with the output terminal of an (N−1)-th stage shift register, and reset signal terminals of the N-th row of the pixel circuits are connected with the output terminal of an (N−2)-th stage shift register.

18. A method for driving a pixel circuit, configured to drive the pixel circuit according to claim 1, the method comprising:
providing, by a node control sub-circuit, a signal of an initial signal terminal to a first node under control of a reset signal terminal, providing, by the node control sub-circuit, a signal of a data signal terminal to a second node under control of a first scanning terminal, and providing, by the node control sub-circuit, a signal of a ground terminal to the second node or providing a signal of a ground terminal to the second node and a third node under control of a second scanning terminal;
providing, by a light emitting control sub-circuit, a signal of a first power supply terminal to a fourth node under control of a light emitting control terminal; and
providing, by a driving sub-circuit, a driving current to the first node under control of the second node, the third node and the fourth node.

19. The method according to claim 18, wherein the node control sub-circuit comprises: a first control sub-circuit, a second control sub-circuit and a third control sub-circuit;
when the node control sub-circuit provides the signal of the ground terminal to the second node, providing, by the node control sub-circuit, the signal of the initial signal terminal to the first node under the control of the reset signal terminal, providing, by the node control sub-circuit, the signal of the data signal terminal to the second node under the control of the first scanning terminal, and providing, by the node control sub-circuit, the signal of the ground terminal to the second node or providing the signal of the ground terminal to the second node and the third node under the control of the second scanning terminal, comprises:
providing, by the first control sub-circuit, the signal of the initial signal terminal to the first node under the control of the reset signal terminal;
under the control of the first scanning terminal, providing, by the second control sub-circuit, the signal of the data signal terminal to the second node, and storing a voltage difference between the second node and the ground terminal;
under the control of the second scanning terminal, providing, by the third control sub-circuit, the signal of the ground terminal to the third node, and storing a voltage difference between the first node and the third node.

20. The method according to claim 18, wherein the node control sub-circuit comprises: a first control sub-circuit, a second control sub-circuit and a third control sub-circuit;
when the node control sub-circuit provides the signal of the ground terminal to the second node and the third node, providing, by the node control sub-circuit, the signal of the initial signal terminal to the first node under the control of the reset signal terminal, providing, by the node control sub-circuit, the signal of the data signal terminal to the second node under the control of the first scanning terminal, and providing, by the node control sub-circuit, the signal of the ground terminal to the second node or providing the signal of the ground terminal to the second node and the third node under the control of the second scanning terminal, comprises:
providing, by the first control sub-circuit, the signal of the initial signal terminal to the first node under the control of the reset signal terminal;
under the control of the first scanning terminal, providing, by the second control sub-circuit, the signal of the data signal terminal to the second node, and storing a voltage difference between the second node and the ground terminal, and providing, by the second control sub-circuit, the signal of the ground terminal to the second node under the control of the second scanning terminal;
under the control of the second scanning terminal, providing, by the third control sub-circuit, the signal of the ground terminal to the third node, and storing a voltage difference between the first node and the third node.
